(19) United States
(12) Patent Application Publication
(10) Pub. No.: US 2024/0063533 A1
(43) Pub. Date: Feb. 22, 2024

(54) METHOD FOR MANUFACTURING ANTENNA MODULE CERAMIC SUBSTRATE

(71) Applicant: AMOSENSE CO.,LTD, Cheonan-si, Chungcheongnam-do (KR)

(72) Inventors: Se Ho LEE, Cheonan-si, Chungcheongnam-do (KR); Hyung Il BAEK, Cheonan-si, Chungcheongnam-do (KR); Kyung Hyun RYU, Cheonan-si, Chungcheongnam-do (KR)

(21) Appl. No.: 18/259,380

(22) PCT Filed: Dec. 8, 2021
(86) PCT No.: PCT/KR2021/018515

§ 371 Date: Jun. 26, 2023

(30) Foreign Application Priority Data
Dec. 28, 2020 (KR) 10-2020-0184512
Dec. 8, 2021 (KR) 10-2021-0174474

(51) Int. Cl. H01Q 1/38; H01Q 1/24; H01Q 1/22

(52) U.S. Cl. CPC H01Q 1/38; H01Q 1/245; H01Q 1/2208

(57) ABSTRACT

A method for manufacturing an antenna module ceramic substrate is provided. Provided is a method for manufacturing an antenna module ceramic substrate, according to one embodiment of the present invention, the method comprising the steps of: stacking a first base material layer and a second base material layer so that each of a radiation pattern formed between the first and second base material layers and a connection pattern formed inside the second base material layer to be electrically connected with the radiation pattern are provided; compressing the first and second base material layers; and calcinating the compressed first and second base material layers.

### TECHNICAL FIELD

The present invention relates to a method for manufacturing a substrate for an antenna module, and more specifically to a method for manufacturing a substrate for an antenna module that is capable of uniformly forming the flatness of the substrate.

### BACKGROUND ART

Communication of 5G or higher (hereinafter, referred to as “5G”), which has been developed as a next-generation communication, requires a low-dielectric/low-loss antenna module by using a ceramic substrate and a magnetic sheet that are suitable for the millimeter wave (mmWave) frequency band. In addition, since the 5G antenna module radiation efficiency is lost about 3% due to heat issues and has a problem in that the compatibility is deteriorated, the need to solve the heat problem through the use of a dielectric material and to solve the EMI noise through the use of a separate magnetic material is emerging.

Moreover, the development of low dielectric/low-loss ultra-high frequency materials and antenna modules that are optimized for each application such as repeaters/small cells, mobile appliances, automobiles and the like has been promoted.

In order to achieve such a low dielectric/low loss of the 5G antenna, various attempts are being made on the application of a ceramic substrate. However, when the ceramic substrate is manufactured to be larger than a certain size, flatness tends to decrease due to the characteristics of materials and processes. Therefore, there is an urgent need to develop a technique that is capable of improving the flatness of a ceramic substrate.

### DISCLOSURE

### Technical Problem

The present invention has been devised in view of the above points, and an object of the present invention is to provide a method for manufacturing a ceramic substrate for an antenna module that is capable of uniformly manufacturing the flatness of a ceramic substrate by adjusting the parameters of the manufacturing process of the ceramic substrate.

In addition, another object of the present invention is to provide a method for manufacturing a ceramic substrate for an antenna module that is capable of improving impedance matching by implementing a via electrode for feeding and a via electrode for grounding in a coaxial line structure.

### Technical Solution

In order to solve the above-described problems, the present invention provides a method for manufacturing a ceramic substrate for an antenna module, including the steps of stacking a first base material layer and a second base material layer such that each of a radiation pattern formed between the first and second base material layers and a connection pattern formed inside the second base material layer to be electrically connected with the radiation pattern is provided; compressing the first and second base material layers; and calcinating the compressed first and second base material layers.

In addition, the step of compressing may be performed at a predetermined pressure such that the flatness of the first and second base material layers has a value within a certain range, and the step of calcinating may be performed at a predetermined temperature and time such that the flatness of the first and second base material layers has a value within a certain range.

In addition, the first and second base material layers may be made of different materials.

In addition, the first and second base material layers may be implemented by stacking at least one LTCC substrate, respectively, and the components of the LTCC substrate of the first base material layer and the components of the LTCC substrate of the second base material layer may be different from each other.

In addition, the second material base material layer may be implemented by stacking a plurality of LTCC substrates, and the connection pattern may include a via electrode for feeding that penetrates the plurality of LTCC substrates.

In addition, a via electrode for grounding that penetrates a part of the second base material layer, but is spaced apart from a side surface of the via electrode for feeding and is provided to surround at least some side surface of the via electrode for feeding may be formed on the second base material layer.

In addition, the via electrode for grounding may be disposed to be spaced apart from the radiation pattern in the lower direction of the radiation pattern position, and may not be provided on the uppermost LTCC substrate of the second base material layer.

In addition, the via electrode for grounding may not be provided on the lowermost LTCC substrate of the second base material layer.

In addition, the via electrode for feeding may include first and second via electrodes for feeding that respectively penetrate a plurality of different LTCC substrates among the second base material layer, wherein the first and second via electrodes for feeding may be provided at different plane positions of the second base material layer, and wherein the connection pattern may further include a redistribution layer that electrically connects between the first and second via electrodes for feeding.

In addition, the via electrode for grounding may be disposed to be spaced apart from the redistribution layer in the upper and lower directions of the redistribution layer, and may not be provided on LTCC substrates that contact the upper and lower portions of the LTCC substrate on which the redistribution layer is provided.

In addition, the via electrode for grounding may be disposed to be spaced apart from the redistribution layer in the upper and lower directions of the redistribution layer, and may be provided in an area other than a corresponding portion of the redistribution layer on the first and second LTCC substrates that contact the upper and lower portions of the LTCC substrate on which the redistribution layer is provided.

In addition, a director may be formed at a position corresponding to the radiation pattern on the upper surface of the first base material layer.

In addition, the director may be formed in the step of stacking or may be formed after the step of calcinating.

The director and the radiation pattern may be made of metal materials having different shrinkage rates.

The radiation pattern may emit radio waves of millimeter waves (mmWave).

### Advantageous Effects

According to the present invention, by adjusting the parameters associated with the shrinkage rate of a ceramic and selecting the materials accordingly in the manufacturing process of a ceramic substrate, the flatness of a ceramic substrate to be manufactured can be uniformly manufactured.

Further, in the present invention, since the via electrode for grounding is configured to surround the via electrode for feeding in a concentric circle structure, the via electrode for grounding and the via electrode for feeding are implemented in a coaxial line structure, and thus, it is possible to manufacture a substrate for an antenna module that improves impedance matching and simultaneously improves isolation between power supply circuits.

### DESCRIPTION OF DRAWINGS

FIG. 1 is an exploded view of an antenna module according to an exemplary embodiment of the present invention.

FIG. 2 is a cross-sectional view of the first example of a substrate according to the present invention.

FIG. 3 is a cross-sectional view showing in more detail a part of the first example of a substrate according to the present invention.

FIGS. 4A and 4B are an exploded view of a part of the first example of a substrate according to the present invention.

FIG. 5 is a cross-sectional view of the second example of a substrate according to the present invention.

FIG. 6 is a plan view in section along the dotted line (A-A′ or B-B′) in FIG. 5.

FIG. 7 is a cross-sectional view showing in more detail a part of the second example of a substrate according to the present invention.

FIGS. 8A and 8B are an exploded view of a part of the second example of a substrate according to the present invention.

FIG. 9 is a cross-sectional view showing in more detail a part of the third example of a substrate according to the present invention.

FIGS. 10A and 10B are an exploded view of a part of the third example of a substrate according to the present invention.

FIG. 11 is a plan view of the first example of a first base material layer and a director (or a 2-1 base material layer and a radiation pattern) according to the present invention.

FIG. 12 is a cross-sectional view of the second example of a first base material layer and a director (or a 2-1 base material layer and a radiation pattern) according to the present invention.

FIG. 13 is a plan view of the second example of a first base material layer and a director (or a 2-1 base material layer and a radiation pattern) according to the present invention.

FIG. 14 is a cross-sectional view of the fourth example of a substrate according to the present invention.

FIG. 15 is a flowchart of the method for manufacturing a substrate according to an exemplary embodiment of the present invention.

### MODES OF THE INVENTION

Hereinafter, with reference to the accompanying drawings, the exemplary embodiments of the present invention will be described in detail so that those of ordinary skill in the art can easily practice the present invention. The present invention may be embodied in many different forms and is not limited to the exemplary embodiments described herein. In order to clearly describe the present invention in the drawings, parts that are irrelevant to the description are omitted, and the same reference numerals are assigned to the same or similar elements throughout the specification.

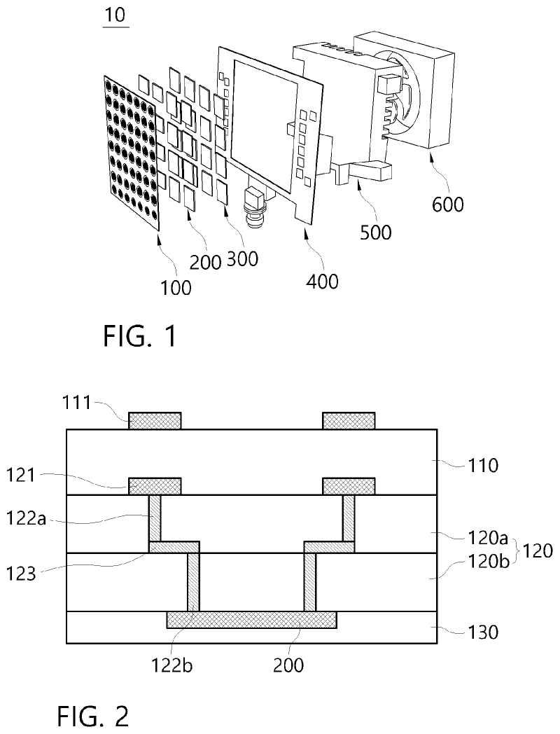

As illustrated in FIG. 1, the antenna module 10 according to an exemplary embodiment of the present invention may include a substrate 100, an RF chipset 200, a thermal interface material (TIM) 300, an evaluation board (EVB) 400, a heat sink 500 and a fan 600.

In the LTCC substrate, an antenna radiation pattern is formed on one side and an RF chipset is disposed on the other side such that a connection pattern for electrically connecting the antenna radiation pattern and the RF chipset may be provided.

The substrate 100 is implemented with a plurality of low-temperature co-fired ceramic (LTCC) substrates. In this case, the substrate 100 is provided with an antenna element on one side and an RF chipset 200 on the other side, and a connection pattern for electrically connecting the radiation pattern 121 and the RF chipset 200 of the antenna element may be provided. The substrate 100 includes a plurality of base material layers 110, 120, 330, and each of the base material layers 110, 120, 330 may be formed by stacking at least one LTCC substrate. In addition, the first and second base material layers 110, 120 may include a conductive pattern made of a conductive material. However, the third base material layer 130 may be a molding layer made of an epoxy molding compound (EMC) or the like instead of the LTCC substrate.

For example, the conductive pattern may respectively include a director 111, a radiation pattern 121 having an antenna function, a via electrode for feeding 122 which is a connection pattern and a redistribution layer 123 for electrically connecting the radiation pattern 121 and the RF chipset 200, and a via electrode for grounding 124 which is disposed to be spaced apart from the periphery of the via electrode for feeding 122. In addition, the conductive pattern may further include ground members 112, 125, 126, 127. In this case, the via electrode for grounding 124 and the ground members 112, 125, 126, 127 may be electrically connected to the ground. In addition, the director 111 and the radiation pattern 121 may be referred to as antenna elements. However, the detailed structure of each conductive pattern will be described below.

The RF chipset 200 is disposed on one side of the substrate 100 and includes an integrated circuit (IC) for transmitting and receiving RF signals. The RF chipset 200 may generate and process an RF signal in a millimeter wave frequency band, and at least one thereof may be provided on the substrate 100. For example, the RF chipset 200 may be disposed on one side of the substrate 100, that is, the third base material layer 130, and may transmit and receive RF signals for each antenna element through its own terminal. The RF signal generated by the RF chipset 200 may be emitted from the radiation pattern 121 through a terminal and a connection pattern of the RF chipset 200. In addition, the external RF signal received by the radiation pattern 121 may be transmitted to the terminal of the RF chipset 200 through the connection pattern and processed by the RF chipset 200. Hereinafter, the structure including the substrate 100 and the RF chipset 200 is referred to as a “module substrate.”

The thermal interface material (TIM) 300 is made of a heat transfer material and is provided on one side of the RF chipset 200, and it may radiate heat generated in the RF chipset 200 to the outside. That is, the TIM 300 is disposed between the RF chipset 200 and the heat sink 500 to transfer heat from the RF chipset 200 to the heat sink 500. The amount of heat transferred to the heat sink 500 by the TIM 300 may be increased.

The evaluation board (EVB) 400 may be electrically connected to the RF chipset 200 to emit various signals to the outside in order to evaluate the function of the antenna module 10. For example, the EVB 400 may include an RF signal input/output terminal for connecting to the module substrate and a DC bias applying terminal, respectively, to estimate and verify the performance of the module substrate.

The heat sink 500 may be disposed on one side of the TIM 300 to diffuse heat emitted from the RF chipset 200 transferred from the TIM 300. That is, the heat sink 500 is in contact with the TIM 300, absorbs and dissipates heat transferred through the TIM 300. In this case, the fan 600 is disposed on one side of the heat sink 500, and it may help heat diffusion or cooling of the heat sink 500 by introducing external air into the heat sink 500.

By disposing the TIM 300, the heat sink 500 and the fan 600 on the rear side of the RF chipset 200, heat generation of the RF chipset 200 can be effectively suppressed or cooled, and thus, characteristics and efficiency in the 5G millimeter wave band may be improved.

Hereinafter, the detailed structure of the substrate 100 (i.e., the detailed structure of each conductive pattern) will be described.

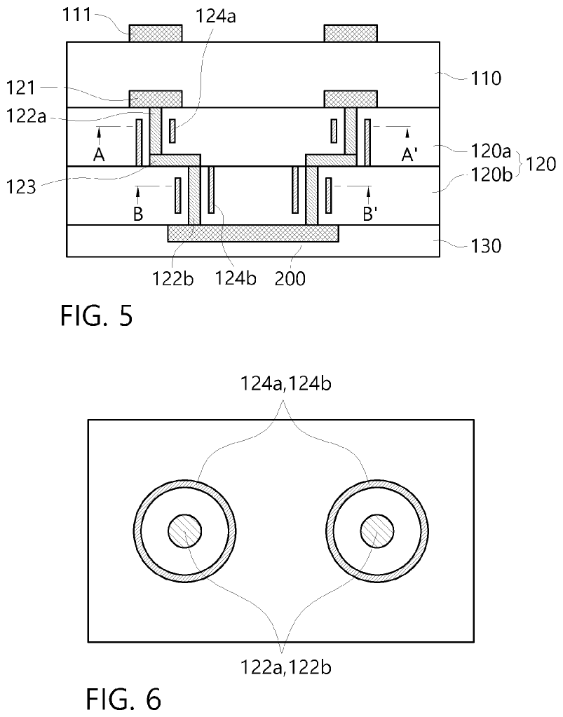

As illustrated in FIGS. 2 and 5, the substrate 100 may include a plurality of base material layers 110, 120, 130 that are sequentially stacked. In this case, each of the base material layers 110, 120, 130 may be implemented by stacking one or more LTCC substrates. However, the third base material layer 130 may be a molding layer made of an epoxy molding compound (EMC) or the like instead of the LTCC substrate.

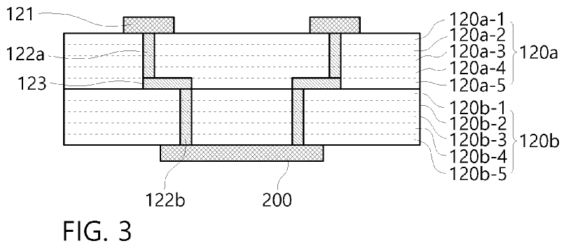

The first base material layer 110 is disposed on the outermost side (i.e., the uppermost side in FIG. 3), and a plurality of directors 111 are provided on the upper surface of the first base material layer 110. In this case, the director 111 is disposed at a position corresponding to the radiation pattern 121, and is disposed to be spaced apart from the radiation pattern 121. Accordingly, the director 111 may increase the gain of the antenna element by increasing the directivity of millimeter waves emitted from the radiation pattern 121.

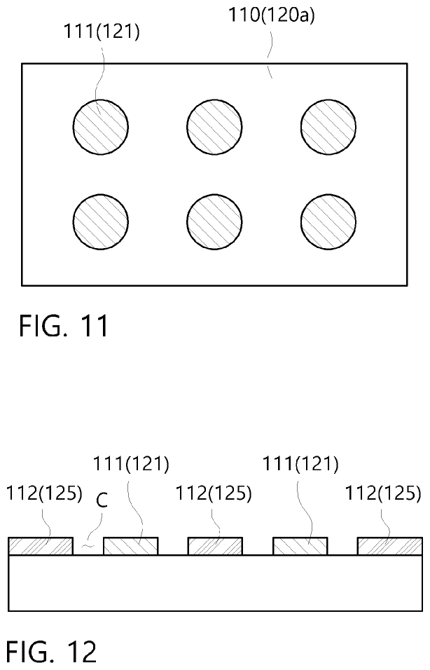

The director 111 may be formed in a shape corresponding to the radiation pattern 121 on the plane of the second base material layer 120. For example, as illustrated in FIG. 11, when the radiation pattern 121 is circular on the plane of the second base material layer 120, the director 111 may also be formed in a circular shape. However, the present invention is not limited thereto, and the director 111 and the radiation pattern 121 may be formed in the shape of an ellipse or polygon (e.g., a quadrangle, etc.) corresponding to each other on the plane of the second base material layer 120. Further, in the plane of the second base material layer 120, the area of the director 111 may be the same as the area of the radiation pattern 121 or smaller than the area of the radiation pattern 121. However, if necessary, the director 111 and the first base material layer 110 may not be provided.

Meanwhile, in FIGS. 2 and 5 of the present invention, it is illustrated that the director 111 is disposed to be spaced apart from the upper portion of one radiation pattern 121, but the present invention is not limited thereto. That is, a plurality of directors 111 may be stacked on one radiation pattern 121 to be spaced apart from each other. In this case, the stacked plurality of directors 111 may be disposed to be spaced apart from each other at an upper portion of the position corresponding to the radiation pattern 121, thereby further increasing the directivity and gain of millimeter waves emitted from the radiation pattern 121.

The second base material layer 120 may be disposed under the first base material layer 110. In this case, a plurality of radiation patterns 121 may be formed on the upper surface of the second base material layer 120. For example, a cavity may be formed under the first base material layer 110, and the radiation pattern 121 may be disposed in the corresponding cavity. To this end, the first base material layer 110 may be implemented with a plurality of LTCC substrates, and a corresponding cavity may be formed in at least a partial area of the lowermost LTCC substrate among the same.

Meanwhile, the RF chipset 200 may be disposed on the lower surface of the second base material layer 120. In this case, the terminal of the RF chipset 200 may be electrically connected to the via electrode for feeding 122 of the connection pad that is exposed on the lower surface of the second base material layer 120. That is, the RF chipset 200 may be disposed on the third base material layer 130. For example, a cavity may be formed on the third base material layer 130, and the RF chipset 200 may be disposed in the corresponding cavity to protect the RF chipset 200. Alternatively, the RF chipset 200 may be protected by molding the third base material layer 130 as a molding layer with respect to the RF chipset 200 that is disposed on the lower surface of the second base material layer 120. In addition, the connection pattern of the via electrode for feeding 122 and the redistribution layer 123 may be included in the second base material layer 120. When the via electrode for grounding 124 is provided, the via electrode for grounding 124 may also be included inside the second base material layer 120. Additionally, the third and fourth grounding members 126, 127 may also be included inside the second base material layer 120.

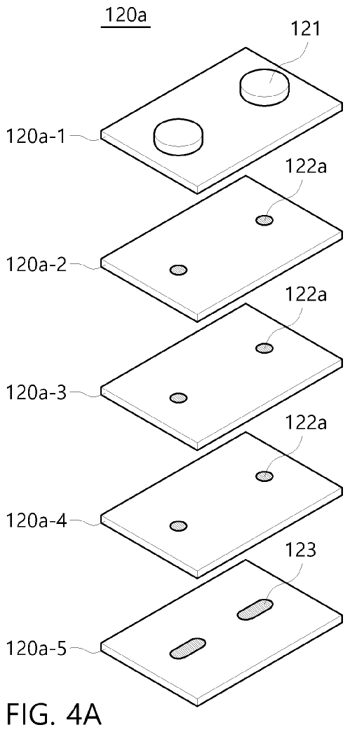

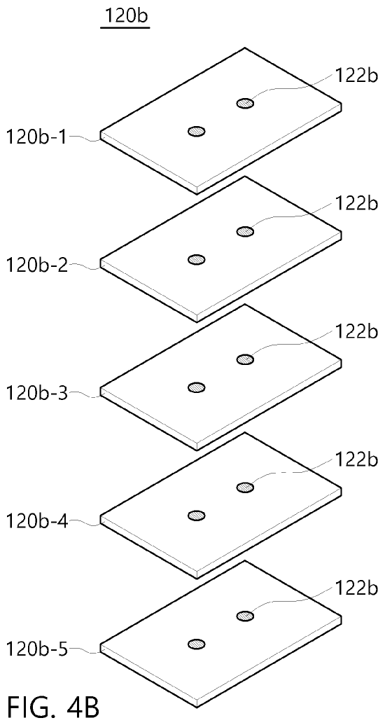

The via electrode for feeding 122 and the redistribution layer 123 are connection patterns that electrically connect the terminal of the RF chipset 200 and the radiation pattern 121, and transmit RF signals. In this case, the via electrode for feeding 122 is a conductive layer that transmits an RF signal in the vertical direction in FIGS. 2 and 5, and it may be formed to penetrate the second base material layer 120. As an example, referring to FIGS. 3, 4 and 7 to 10, in the LTCC substrates 120a-1, 120a-2, 120a-3, 120a-4, 120a-5 of a 2-1 base material layer 120a, a first via electrode for feeding 122a may be formed in some through-areas corresponding to each other. Further, in the LTCC substrates 120b-1, 120b-2, 120b-3, 120b-4, 120b-5 of a 2-2 base material layer 120b, a second via electrode for feeding 122b may be formed in some through-regions corresponding to each other.

The redistribution layer 123 is a conductive layer that transmits an RF signal in the horizontal direction in FIGS. 2 and 5, and it is electrically connected to the via electrode for feeding 122 and may be formed to penetrate at least one LTCC substrate. That is, the first via electrode for feeding 122a and the second via electrode for feeding 122b may be formed at different positions on the plane of the base material layer 120, and the redistribution layer 123 may be electrically connected therebetween. As an example, referring to FIGS. 3, 4 and 7 to 10, the redistribution layer 123 may be formed on one LTCC substrate 120a-5 of the 2-1 base material layer 120 so as to be connected to a first via electrode for feeding 122a. However, the present invention is not limited thereto, and the redistribution layer 123 may be formed on the 2-2 base material layer 120b.

Meanwhile, referring to FIGS. 5 to 10, a via electrode for grounding 124 may be provided on the second base material layer 120. In this case, the via electrode for grounding 124 must all be disposed to be electrically insulated from the via electrode for feeding 122, the radiation pattern 121, the redistribution layer 123 and the RF chipset 200. That is, the via electrode for grounding 124 is spaced apart from the horizontal direction (side surface) of the via electrode for feeding 122, and it must not be exposed on the upper and lower surfaces of the 2-1 base material layer 120a and the 2-2 base material layer 120b, and it must be spaced apart up and down with respect to the terminals of the radiation pattern 121 and the RF chipset 200 and the redistribution layer 123 that are disposed on the upper portion or lower portion of the second base material layer 120.

In order to correspond to each arrangement condition of the via electrode for grounding 124, the second base material layer 120 may preferably be implemented by stacking a plurality of LTCC substrates. That is, it is preferable that the 2-1 base material layer 120a is implemented in a form where a plurality of LTCC substrates 120a-1, 120a-2, 120a-3, 120a-4, 120a-5 are stacked, and the 2-2 base material layer 120b is implemented in a form where a plurality of LTCC substrates 120b-1, 120b-2, 120b-3, 120b-4, 120b-5 are stacked. However, the number of the plurality of LTCC substrates of the 2-1 base material layer 120a and the 2-2 base material layer 120b is not limited to those illustrated in the drawings. The more detailed description of each arrangement condition of the via electrode for grounding 124 will be described below.

The via electrode for grounding 124 is disposed to be spaced apart from the periphery of the via electrode for feeding 122. However, the via electrode for grounding 124 must be electrically insulated from the via electrode 122 for feeding. Accordingly, the via electrode for grounding 124 is formed to be spaced apart from the via electrode 122 for power supply by a predetermined distance in the horizontal direction as shown in in FIGS. 2 and 5. In this case, as illustrated in FIG. 6, when viewed from the plane of the cross-section along the dotted line (A-A′ or B-B′) of the second base material layer 120, the via electrode for grounding 124 is disposed to be spaced apart from the via electrode for feeding 122 while being concentric with the via electrode for feeding 122, and accordingly, the via electrode for feeding 122 and the via electrode for grounding 124 form the structure of a coaxial line.

Since the millimeter wave frequency band has a very short wavelength, the mutual influence between the connection patterns is very large, and thus, impedance matching is very difficult. Accordingly, in the present invention, by disposing the via electrode for grounding 124 that is spaced apart from the periphery of the via electrode for feeding 122 through the above-described coaxial line structure, it is possible to easily achieve impedance matching with respect to the connection pattern, and at the same time, the degree of isolation between the power supply circuits can be improved.

For the structure of a coaxial line, in at least one LTCC substrate of the 2-1 base material layer 120a, the first via electrode for grounding 124a has a through-portion of the first via electrode for feeding 122a therebetween, and it may be formed so as to penetrate a spaced apart portion around the same. Further, in at least one LTCC substrate of the 2-2 base material layer 120b, the second via electrode for grounding 124b may be formed to pass through the spaced apart portion of the second via electrode for feeding 122b with the penetrating portion interposed therebetween. In this case, the through-portions of the first via electrode for feeding 122a and the second via electrode for feeding 122b may be formed at different positions on the plane of the LTCC substrate.

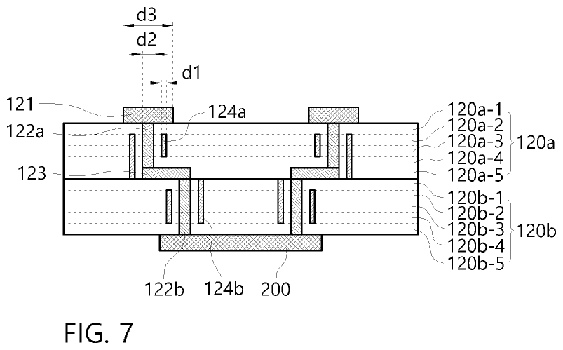

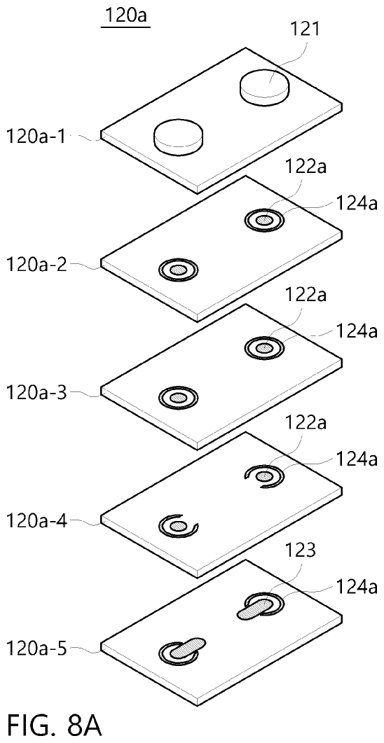

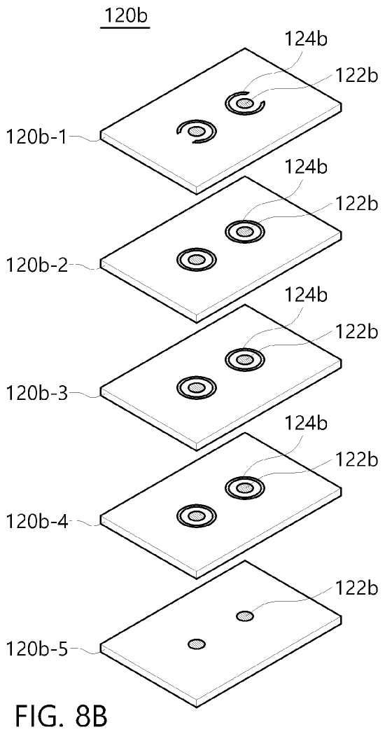

For example, as illustrated in FIGS. 7 and 8, in some LTCC substrates 120a-2, 120a-3, 120a-4, 120a-5 of the 2-1 base material layer 120a, the first via electrode for grounding 124a may be formed at a spaced apart portion with the through-portion of the via electrode for feeding 122a therebetween. In this case, in the case of the LTCC substrates 120a-2, 120a-3 of the 2-1 base material layer 120a, the first via electrode for grounding 124a is formed so as to go all around the through-portion of the first via electrode for feeding 122a. On the other hand, in the case of the LTCC substrates 120a-4 and 120a-5 of the 2-1 base material layer 120a, the via electrode for grounding 124 is formed only in the area except for the corresponding portion of the redistribution layer 123. This is because the first via electrode for grounding 124a must not contact the redistribution layer 123 as well as the first via electrode for feeding 122a.

Further, in some of the LTCC substrates 120b-1, 120b-2, 120b-3, 120b-4 of the 2-2 base material layer 120b, the second via electrode for grounding 124b may be formed at a spaced apart portion with the through-portion of the via electrode for feeding 122b therebetween. In this case, in the case of the LTCC substrates 120b-2, 120b-3, 120b-4 of the 2-2 base material layer 120b, the second via electrode for feeding 122b is formed so as to go all around the through-portion of the second via electrode for feeding 122b. On the other hand, in the case of the LTCC substrate 120b-1 of the 2-2 base material layer 120b, the second via electrode 124b for grounding is formed only in the area except for the corresponding portion of the redistribution layer 123. This is because the second via electrode for grounding 124b must not be in contact with the redistribution layer 123 as well as the second via electrode for feeding 122b.

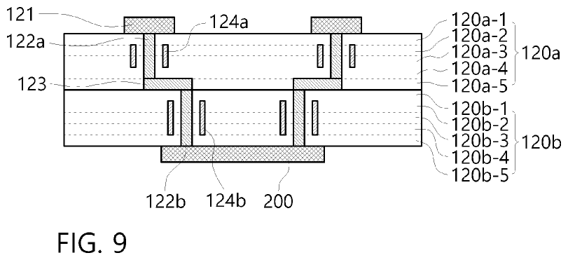

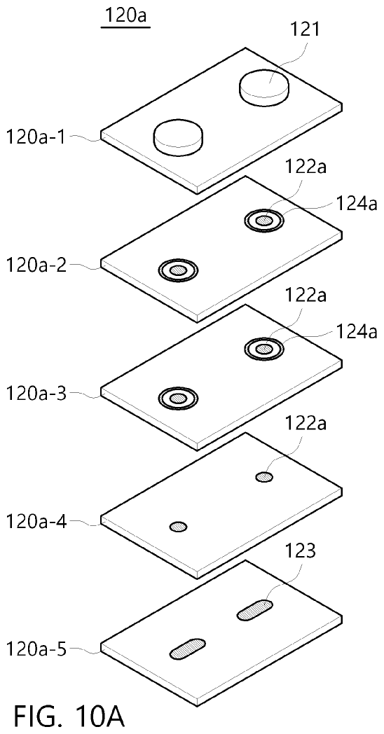

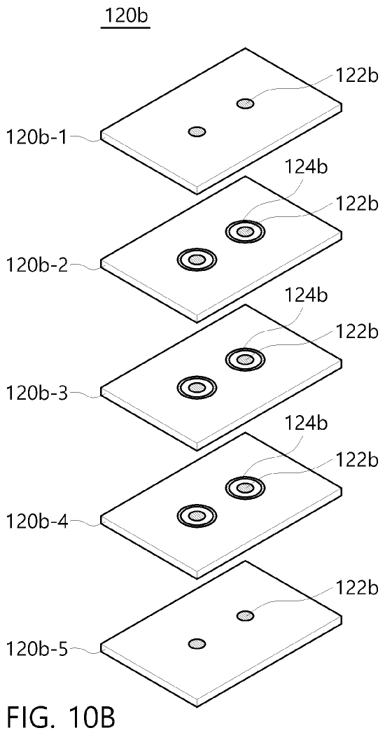

Meanwhile, as illustrated in FIGS. 9 and 10, the via electrode for grounding 124 may be formed only on the LTCC substrates 120a-2, 120a-3 of the 2-1 base material layer 120a, and the LTCC substrates 120b-2, 120b-3, 120b-4 of the 2-2 base material layer 120b. That is, unlike the case illustrated in FIGS. 7 and 8, the via electrode for grounding 124 may not be formed on the LTCC substrates 120a-4, 120a-5, 120b-1.

The via electrode for grounding 124 must be electrically insulated from the radiation pattern 121 as well. Accordingly, the via electrode for grounding 124 is formed to be spaced apart from the radiation pattern 121 that is located on the uppermost portion of the second base material layer 120 in the lower direction of the position. For example, the via electrode for grounding 124 may not be formed on the uppermost LTCC substrate 120a-1 of the 2-1 base material layer 120a.

The via electrode for grounding 124 must be electrically insulated from the redistribution layer 123. Accordingly, the via electrode for grounding 124 is formed to be spaced apart in the upper and lower directions of the redistribution layer 123. For example, in the LTCC substrates 120a-4, 120a-5 of the 2-1 base material layer 120a and the LTCC substrate 120b-1 of the 2-2 base material layer 120b, the via electrode for grounding 124 may not be formed, or the via electrode for grounding 124 may be formed only in the area excluding the corresponding portion of the redistribution layer 123.

The via electrode for grounding 124 must be electrically insulated from the RF chipset 200 as well. Accordingly, the via electrode for grounding 124 is formed to be spaced apart from the RF chipset 200 that is located at the lowermost portion of the second base material layer 120 in the upward direction. For example, the via electrode for grounding 124 may not be formed on the lowermost LTCC substrate 120b-5 of the 2-2 second base material layer 120b.

In particular, since the via electrode for feeding 122 corresponds to a transmission line of an RF signal, it is preferable that the thickness d₂ is the same as the thickness d₁ of the via electrode for grounding 124 or greater than d₁. Certainly, since the radiation pattern 121 must perform an antenna function, it is preferable that the diameter d₃ in the plane of the radiation pattern 121 is larger than d₁ and d₂. Similarly, the diameter in the plane of the director 111 that is formed to correspond to the radiation pattern 121 is preferably larger than d₁ and d₂.

Referring to FIG. 12, a first grounding member 112 may be additionally formed on the upper surface of the first base material layer 110 in addition to the director 111. The first grounding member 112 is disposed to be spaced apart from the director 111 so as not to contact the director 111 on the upper surface of the first base material layer 110. That is, on the upper surface of the first base material layer 110, a cavity C is formed between the first grounding member 112 and the director 111. The first grounding member 112 may be disposed to surround the periphery of the director 111 on a plane, and may be electrically connected to the ground.

In addition, a second grounding member 125 may be additionally formed on the upper surface of the 2-1 base material layer 120a in addition to the radiation pattern 121. The second ground member 125 is disposed to be spaced apart from the radiation pattern 121 so as not to contact the radiation pattern 121 on the upper surface of the 2-1 base material layer 120a. That is, on the upper surface of the first base material layer 110, a cavity C is formed between the second ground member 125 and the radiation pattern 121. The second ground member 125 may be disposed to surround the periphery of the radiation pattern 121 on a plane, and may be electrically connected to the ground.

In addition, referring to FIG. 14, third and fourth grounding members 126, 127 may be additionally formed in the second base material layer 120. In this case, the third ground member 126 is formed on at least one of the LTCC substrates of the 2-1 base material layer 120a, and is electrically connected to the first via electrode for grounding 124a. In addition, the fourth ground member 127 is formed on at least one of the LTCC substrates of the 2-2 second base material layer 120b, and is electrically connected to the second via electrode for grounding 124b. The third and fourth grounding members 126, 127 are electrically connected to the ground, thereby connecting the via electrode for grounding 124 to the corresponding ground.

Meanwhile, in FIG. 2 and the like, the director 111 is illustrated as protruding from the upper surface of the first base material layer 110, but the present invention is not limited thereto. That is, the director 111 may be formed in a form where a cavity is formed on the upper surface of the first base material layer 110 and a conductive material is filled in the formed cavity. For example, in at least the uppermost LTCC substrate among the LTCC substrates of the first base material layer 110, a through-hole according to the corresponding cavity may be formed, and a conductive material may be filled in the formed through-hole to form the director 111.

In addition, although the radiation pattern 121 is illustrated as protruding from the upper surface of the 2-1 base material layer 120a in FIG. 2 and the like, the present invention is not limited thereto. That is, a cavity may be formed on the upper surface of the 2-1 base material layer 120a, and the radiation pattern 121 may be formed in a form where the formed cavity is filled with a conductive material. For example, in at least the uppermost LTCC substrate 120a-1 among the LTCC substrates 120a-1, 120a-2, 120a-3, 120a-4, 120a-5 of the 2-1 base material layer 120a, a through-hole according to the corresponding cavity may be formed, and a conductive material may be filled in the formed through-hole to form the radiation pattern 321. In this case, the second ground member 125 may also be formed in the same form as the radiation pattern 121. However, it may be preferable that the first via electrode for grounding 124a is not formed on the uppermost LTCC substrate 320a-1 of the 2-1 base material layer 320a, unlike as illustrated in FIG. 7 and the like.

Hereinafter, the method for manufacturing a substrate 100 will be described.

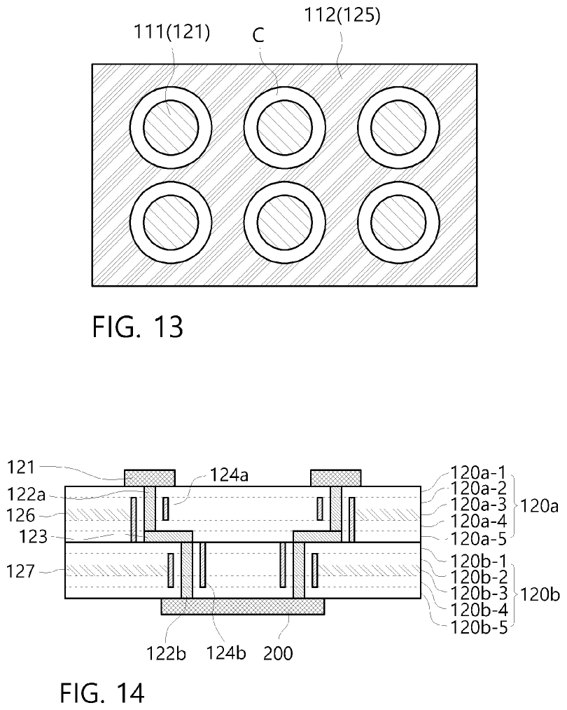

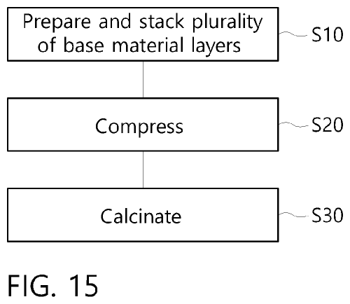

As shown in FIG. 15, the method for manufacturing a substrate 100 according to an exemplary embodiment of the present invention may include the steps of stacking a plurality of base material layers 110, 120 (S10), compressing the plurality of base material layers 110, 120 (S20), and calcinating the plurality of base material layers 110, 120 (S30), respectively. Herein, the substrate 100 manufactured by the manufacturing method is a ceramic substrate, and it is intended to be used for the purpose of the antenna module 10 described above with reference to FIGS. 1 to 14.

First of all, a plurality of base material layers 110, 120 are prepared and stacked (S10).

In this case, the radiation pattern 121 is formed on the upper surface of the second base material layer 120. The radiation pattern 121 may be provided under the first base material layer 110. That is, a cavity may be formed under the first base material layer 120, and the radiation pattern 121 may be disposed in the formed cavity. Certainly, on the upper surface of the second base material layer 120, in addition to the radiation pattern 121, a second grounding member 125 may be additionally formed in the same manner as the radiation pattern 121.

In addition, connection patterns of the via electrode for feeding 122 and the redistribution layer 123 are formed inside the second base material layer 120. Certainly, the via electrode for grounding 124 may also be formed inside the second base material layer 120. Additionally, third and fourth grounding members 126, 127 may be formed inside the second base material layer 120.

In particular, the plurality of base material layers 110, 120 may be implemented by stacking at least one low-temperature co-fired ceramic (LTCC) substrate, respectively. In this case, a director 111, a via electrode for feeding 122, a redistribution layer 123, ground members 112, 125, 126, 127, and a via electrode for grounding 124 may be formed on each LTCC substrate.

For example, in the lower LTCC substrate of the first base material layer 120, the radiation pattern 121 may be formed by forming a cavity at the corresponding position of the radiation pattern 121 and injecting a conductive layer into the formed through portion. Certainly, in the case of the first grounding member 112, the first grounding member 112 may be formed by forming a penetration portion in the lower LTCC substrate of the first base material layer 110 and injecting the conductive layer.

Further, in the LTCC substrate of the second base material layer 120, a via electrode for feeding 122 and a redistribution layer 123 may be formed by forming a through-portion at the corresponding positions of the via electrode for feeding 122 and the redistribution layer 123, and injecting a conductive layer into the formed through-portion. Certainly, the configurations of the via electrode for grounding 124 and the third and fourth grounding members 126, 127 may also be formed through the formation of a through-portion for the corresponding position in the LTCC substrate of the second base material layer 120 and the injection of the conductive layer. Further, in the case of the second grounding member 125, the second grounding member 125 may be formed by forming a through-portion and implanting a conductive layer in the lower LTCC substrate of the first base material layer 110.

Thereafter, a plurality of base material layers 110, 120, 130 in which a radiation pattern 121, a via electrode for feeding 122, a redistribution layer 123, ground members 112, 125, 126, 127, and a via electrode for grounding 124 are selectively formed are stacked according to their corresponding positions.

However, since the detailed structure of a plurality of base material layers 110, 120 and the detailed structures of the via electrode for feeding 122, the redistribution layer 123, the grounding members 112, 125, 126, 127, and the via electrode for grounding 124 formed on the plurality of base material layers 110, 120, 130 have been described above with reference to FIGS. 1 to 14, the descriptions thereof will be omitted below.

Meanwhile, by applying a low pressure to the stacked LTCC substrates at a low temperature, the plurality of base material layers 110, 120 may be prepared. That is, by stacking the LTCC substrates of the second base material layer 120 and applying a pressure lower than the pressure in S20 at a temperature lower than the temperature in S30 to the stacked LTCC substrates, the second base material layer 120 may be prepared. This process may also be applied to the first base material layer 110. For example, by applying a pressure of 5 to 25 kgf/cm² at a temperature of 25 to 90° C. to the LTCC substrates of the stacked second base material layer 120 to bond the LTCC substrates, the second base material layer 120 may be prepared.

Next, the plurality of stacked base material layers 110, 120 are compressed (S20).

In this case, pressure may be applied from the top and bottom to the plurality of stacked base material layers 110, 120. In particular, compression may be performed at a predetermined pressure such that the flatness of the first base material layer 110 and the second base material layer 120 is uniform, that is, the flatness of the first base material layer 110 and the second base material layer 120 has a value within a certain range.

Next, the plurality of compressed base material layers 110, 120 are calcinated (S30).

That is, the plurality of base material layers 110, 120 compressed in S20 may be calcinated at a predetermined temperature. In this case, calcination may be performed at a predetermined temperature and time such that the flatness of the plurality of base material layers 110, 120 is uniform, that is, the flatness of the first base material layer 110 and the second base material layer 120 has a value within a certain range. For example, it may be calcinated at a temperature of 700° C. to 1,000° C. for 1 hour or less.

The substrate 100 manufactured according to S20 and S30 may have excellent flatness without warping or bending, and may have, for example, a flatness of 0.5 to 3 μm.

Meanwhile, S20 and S30 may be simultaneously performed. That is, the plurality of stacked base material layers 110, 120 may be compressed while performing the calcinating process. Even in this case, it is possible to obtain the substrate 100 having excellent flatness without warping or bending, and having a flatness of, for example, 0.5 to 3 μm.

Meanwhile, the director 111 is formed on the upper surface of the first base material layer 110. For example, the director 111 may be formed on the upper surface of the first base material layer 110 by the screen printing method or the like. However, it may be preferable that the director 111 is formed in S10 and undergoes compression and calcinating processes according to S20 and S30, but it may not be formed in S10 but may be formed after S30.

Certainly, a first grounding member 112 may be additionally formed on the upper surface of the first base material layer 110 in addition to the director 111. The first grounding member 112 may also be formed together with the director 111 in S10 and undergo the compression and calcinating processes according to S20 and S30, or it may be formed after S30 instead of being formed in S10.

In addition, after S30, an RF chipset 200 may be disposed on the lower surface of the second base material layer 120. The RF chipset 200 may be disposed on the third base material layer 130. As an example, a cavity may be formed on the upper portion of the third base material layer 130 implemented as an LTCC substrate, and the RF chipset 200 may be protected by stacking the third base material layer 130 under the structure of the first and second base material layers 110, 120 in a manner of disposing the RF chipset 200 in the formed cavity.

In this case, the structure of the first and second base material layers 110, 120 and the third base material layer 130 may be stacked such that the positions of the via electrode for feeding 122 exposed on the lower surface of the second base material layer 120 and the terminal of the RF chipset 200 correspond. In particular, for the stacked structure of the first and second base material layers 110, 120 and the third base material layer 130, compression and calcinating processes may be additionally performed. In this case, the additional compression and calcination may be performed at a pressure and temperature lower than those of S20 and S30.

Alternatively, the RF chipset 200 may be protected by molding the third base material layer 130, which is a molding layer composed of an epoxy molding compound (EMC) and the like. with respect to the RF chipset 200 disposed on the lower surface of the second base material layer 120.

Meanwhile, the first base material layer 110 and the second base material layer 120 may be made of different materials. That is, the LTCC substrate of the first base material layer 110 and the LTCC substrate of the second base material layer 120 may be made of different components or may have different ratios of the constituents. That is, the shrinkage rate of the LTCC substrate of the first base material layer 110 may be different from the shrinkage rate of the LTCC substrate of the second base material layer 120. Under these conditions, in the compression and calcinating processes according to S20 and S30, the plurality of base material layers 110, 120 compensate for the degree of shrinkage and expansion such that the flatness of the plurality of base material layers 110, 120 may be more uniform.

For example, the first and second base material layers 110, 120 may be implemented as LTCC substrates made of different glass-ceramic materials. For example, at least one of SiO₂—CaO—Al₂O₃-based glass, SiO₂—MgO—Al₂O₃-based glass and SiO₂—B₂O₃—CaO—R₂O-based glass may be included in the LTCC substrate of the first base material layer 110, and the other one may be included in the LTCC substrate of the second base material layer 120.

In addition, the director 111 and the radiation pattern 121 may be formed of metal materials having different shrinkage rates. Under these conditions, in the compression and calcinating processes according to S20 and S30, the director 111 and the radiation pattern 121 compensate for the degree of shrinkage and expansion affecting the plurality of base material layers 110, 120 with each other such that the flatness of the base material layers 110, 120 may be more uniform.

Although an exemplary embodiment of the present invention has been described above, the spirit of the present invention is not limited to the exemplary embodiments presented herein, and those skilled in the art who understand the spirit of the present invention may easily suggest other exemplary embodiments by modifying, changing, deleting or adding components within the scope of the same spirit, but this will also fall within the scope of the present invention.

### INDUSTRIAL APPLICABILITY

The present invention relates to a method for manufacturing a substrate for an antenna module, and since it is possible to provide a method for manufacturing a substrate for an antenna module that is capable of uniformly forming the flatness of the substrate, it has industrial applicability.

1. A method for manufacturing a ceramic substrate for an antenna module, comprising the steps of:
stacking a first base material layer and a second base material layer such that each of a radiation pattern formed between the first and second base material layers and a connection pattern formed inside the second base material layer to be electrically connected with the radiation pattern is provided;
compressing the first and second base material layers; and
calcinating the compressed first and second base material layers,
wherein the step of compressing is performed at a predetermined pressure such that the flatness of the first and second base material layers has a value within a certain range, and
wherein the step of calcinating is performed at a predetermined temperature and time such that the flatness of the first and second base material layers has a value within a certain range.

2. The method of claim 1, wherein the first and second base material layers are made of different materials.

3. The method of claim 2, wherein the first and second base material layers are implemented by stacking at least one LTCC substrate, respectively, and
wherein the components of the LTCC substrate of the first base material layer and the components of the LTCC substrate of the second base material layer are different from each other.

4. The method of claim 1, wherein the second material base material layer is implemented by stacking a plurality of LTCC substrates, and
wherein the connection pattern comprises a via electrode for feeding that penetrates the plurality of LTCC substrates.

5. The method of claim 4, wherein a via electrode for grounding that penetrates a part of the second base material layer, but is spaced apart from a side surface of the via electrode for feeding and is provided to surround at least some side surface of the via electrode for feeding is formed on the second base material layer.

6. The method of claim 5, wherein the via electrode for grounding is disposed to be spaced apart from the radiation pattern in the lower direction of the radiation pattern position, and is not provided on the uppermost LTCC substrate of the second base material layer.

7. The method of claim 5, wherein the via electrode for grounding is not provided on the lowermost LTCC substrate of the second base material layer.

8. The method of claim 5, wherein the via electrode for feeding comprises first and second via electrodes for feeding that respectively penetrate a plurality of different LTCC substrates among the second base material layer,
wherein the first and second via electrodes for feeding are provided at different plane positions of the second base material layer, and
wherein the connection pattern further comprises a redistribution layer that electrically connects between the first and second via electrodes for feeding.

9. The method of claim 8, wherein the via electrode for grounding is disposed to be spaced apart from the redistribution layer in the upper and lower directions of the redistribution layer, and is not provided on LTCC substrates that contact the upper and lower portions of the LTCC substrate on which the redistribution layer is provided.

10. The method of claim 8, wherein the via electrode for grounding is disposed to be spaced apart from the redistribution layer in the upper and lower directions of the redistribution layer, and is provided in an area other than a corresponding portion of the redistribution layer on the first and second LTCC substrates that contact the upper and lower portions of the LTCC substrate on which the redistribution layer is provided.

11. The method of claim 1, wherein a director is formed at a position corresponding to the radiation pattern on the upper surface of the first base material layer.

12. The method of claim 11, wherein the director is formed in the step of stacking or is formed after the step of calcinating.

13. The method of claim 11, wherein the director and the radiation pattern are made of metal materials having different shrinkage rates.

14. The method of claim 1, wherein the radiation pattern emits radio waves of millimeter waves (mmWave).
